(19) United States
(12) Patent Application Publication
(10) Pub. No.: US 2003/0198151 A1
(43) Pub. Date: Oct. 23, 2003

(54) Focus control device

(75) Inventors: Tooru Iwatani, Tokyo (JP); Yoshihiro Kozawa, Tokyo (JP)

Correspondence Address: SUGHRUE MION, PLLC, 2100 PENNSYLVANIA AVENUE, N.W., WASHINGTON, DC, 20037, US

(73) Assignee: MITSUBISHI DENKI KABUSHIKI KAISHA

(21) Appl. No.: 10/417,085

(22) Filed: Apr. 17, 2003

(30) Foreign Application Priority Data
Apr. 18, 2002 (JP) 2002-116527

(51) Int. Cl. G11B 7/095

(52) U.S. Cl. 369/44.29

(57) ABSTRACT

A focus control device includes a moving member integral with an object lens, a focus actuator for moving the object lens toward or away from a recording surface of an optical disc in a direction of focusing, a tracking actuator for moving the object lens in a direction of tracking, and a control unit for biasing the moving member in the direction of tracking so that the moving member is pressed against a fixed member by using the tracking actuator, and for enabling the moving member to carry out a focusing operation while the moving member is pressed against the fixed member by using the focus actuator. Thus the focus control device can surely carry out a focusing operation without being under the influence of turbulence vibrations or the like that may be generated.

### BACKGROUND OF THE INVENTION

1. Field of the Invention

The present invention relates to a focus control device for use in disc drives for playing back an optical disc storage media (referred to as an optical disc from here on), such as a compact disc (CD), a CD-ROM, or a magnetic optical disc (MO).

2. Description of Related Art

FIG. 7 is a block diagram showing the structure of a prior art disc drive, FIG. 8 is a perspective view showing an enlarged main part of an optical pickup for use in the disc drive shown in FIG. 7, FIG. 9 is circuit diagram showing a part of circuitry included in the disc drive shown in FIG. 7, FIG. 10 is a graph showing characteristics of the optical pickup shown in FIG. 8, FIG. 11 is a graph showing a relationship between a focus control signal and a focus error signal in the disc drive shown in FIG. 7, ad FIG. 12 is a graph showing a relationship among the focus control signal, the focus error signal, and a lens displacement when the optical pickup vibrates. In the graphs of FIGS. 10 to 12, small-amplitude signals, small displacements, and so on can be represented by simple straight lines or curves, for convenience' sake, and relatively-large-amplitude signals, relatively large displacements, and so on can be represented by specific curves so that changes in them become clear.

In FIGS. 7 and 8, reference numeral 1 denotes an optical disc, reference numeral 2 denotes an optical pickup that is arranged opposite to and under a recording surface of the optical disc 1, for reading information recorded on the optical disc 1 as an optical signal, and for converting it into an electrical signal, reference numeral 3 denotes a spindle motor for applying a rotational driving force to the optical disc 1, reference numeral 4 denotes an RF amplifier for amplifying the electrical signal obtained by the optical pickup 2, reference numeral 5 denotes a servo IC for sending an electrical signal used to place the optical disc 1 at a predetermined relative position with respect to the optical pickup 2 to either a control unit or a driver, which will be mentioned below, based on the electrical signal from the RF amplifier 4, reference numeral 6 denotes the control unit for sending a control signal used to adjust the relative position of the optical pickup 2 with respect to the optical disc 1 to the driver, and reference numeral 7 denotes the driver for driving a focus actuator 14 and a tracking actuator 16 in order to control the position of the optical pickup 2 according to a focus control signal and a tracking control signal sent from the servo IC 5 as shown in FIG. 9.

The optical pickup 2 is disposed on a playing-back base (not shown in the figure) that does seeks in a direction of a radius of the optical disc 1, as shown in FIG. 8, and is generally constructed of an object lens 12 integral with a frame 10 having a rectangular cross section, for focusing a laser beam from a laser drive circuit (not shown in the figure) on the optical disc 1, the focus actuator 14 for moving this object lens 12 in a direction of movement (i.e., a focusing direction designated by an arrow F of FIG. 8) toward or away from the recording surface of the optical disc 1, and the tracking actuator 16 for moving the object lens 12 in a direction of the perimeter of the optical disc 1 (i.e., a tracking direction designated by an arrow T of FIG. 8).

A yoke 18 that stands up on the playing-back base (not shown in the figure) is inserted into an opening 10a of the frame 10 so that the yoke 18 is not in contact with the frame 10, and a focusing coil 20 is wound around an outer wall of the frame 10. The yoke 18 and the focusing coil 20 constitute the focus actuator 14. Both ends 20a and 20b of the focusing coil 20 are supported with tension by a wall member 22 that stands up on the playback base (not shown in the figure) and are connected with a power supply (not shown in the figure).

Two tracking Coils 24 are disposed on both end surfaces of the frame 10 that are perpendicular to the direction of tracking while they are separated from the focusing coil 20 by insulators (not shown in the figure). Furthermore, two magnets 26 are disposed on the playback base (not shown in the figure) in the vicinity of the frame 10 so that they are opposite to the two tracking coils 24, respectively. The two tracking coils 24 and the two magnets 26 constitute the tracking actuator 16. Both ends 24a and 24b of the tracking coil 24 are supported with tension by the wall member 22 and are connected with a power supply (not shown in the figure).

The frame 10 is a moving member that is elastically supported by the four coil ends, i.e., the both ends 20a and 20b of the focusing coil 20 and the both ends 24a and 24b of the tracking coil 24, like a cantilever, so that the frame 10 can be moved with respect to the wall member 22 in the directions designated by the arrows F and T. Therefore, the optical pickup 2 has gain characteristics showing Q value at the natural resonance frequency f0 (which is the gain at the resonance frequency and which indicates the sharpness of resonance), as shown in FIG. 10. The yoke 18 is arranged at the center of the opening 10a of the frame 10 (or the yoke is placed at a tracking center position) before any control signal is applied to the tracking actuator 16. The four coil ends serve as a suspension of the moving member, and each of the coil ends has a surface covered with insulating coating (not shown in the figure).

Next, a description will be made as to an operation of the prior art disc drive. When starting to play back the optical disc 1, the prior art disc drive causes the playback base (not shown in the figure) to do seeks in a direction of a radius of the optical disc 1 by using a stepping motor (not shown in the figure) and makes the playback base stop at a predetermined position. The driver 7 then drives the focus actuator 14 according to the focus control signal sent from the servo IC 5 so as to change the relative position of the optical pickup 2 with respect to the optical disc 1 in a direction designated by the arrow F. FIG. 11 shows a relationship between the focus control signal having a triangular waveform for displacing the optical pickup 2 in a direction designated by the arrow F under the normal condition and the focus error signal generated at that time. In other words, when the focus control signal is applied to the driver 7, the driver 7 drives the optical pickup 2 so that the optical pickup 2 approaches the optical disc 1 and, after that, reversely, gradually moves away from a predetermined position when the optical pickup 2 approaches the predetermined position. The prior art disc drive carries out a focusing operation through the object lens 12 of the optical pickup 2 while the optical pickup 2 is thus made to sweep. This focusing operation is continued until focusing is obtained with a focus servoloop. As shown in FIG. 11, when the focus control signal has a level of about 0, the focus error signal is adjusted so as to also have a level of 0.

The driver 7 then drives the tracking actuator 16 according to the tracking control signal sent from the servo IC 5 so as to correct a displacement of the optical axis of the object lens 12 with respect to a predetermined part of the recording surface of the optical disc 1. As a result, recorded information on the optical disc 1 can be played back.

By the way, as previously mentioned, the optical pickup 2 has a gain characteristic showing Q value at the resonance frequency f0. Therefore, when turbulence vibrations are generated at a frequency close to the resonance frequency f0, it is difficult to carry out a focus retracting operation because the optical pickup 2 resonates according to the amount of Q value. In other words, as shown in FIG. 12, when a focus control signal having a triangular waveform is applied to the driver 7, the driver 7 causes the object lens 12 to carry out a focusing operation according to the focus control signal. At that time, when turbulence vibrations are generated at a frequency close to the resonance frequency f0, the displacement of the object lens 12 falls into disorder greatly and a specific focus error signal is created. Under such a condition, the prior art disc drive cannot carry out a final focus retracting operation because the position of the object lens 12 is not steady.

Japanese patent application publication (TOKKAIHEI) No. 5-109085 discloses a focus control device for controlling an object lens so that the object lens moves toward an optical disc by using a focus actuator when the object lens begins to move away from the optical disc due to turbulence vibrations or the like.

Japanese patent application publication (TOKKAIHEI) No.9-306000 discloses a focus control device that sets the resonance frequency of a two-axis actuator for moving a lens holder holding an object lens with respect to a fixed member to be higher than the resonance frequency of a mechanical deck to which the fixed member is fixed, and that attenuates vibrations caused by the two-axis actuator.

A problem encountered with prior art focus control devices constructed as mentioned above is that while they can reduce the influence of turbulence vibrations or the like exerted upon a disc drive, they cannot exclude the influence completely.

### SUMMARY OF THE INVENTION

The present invention is proposed to solve the above-mentioned problem, and it is therefore an object of the present invention to provide a focus control device that can surely carry out a focusing operation without being under the influence of turbulence vibrations or the like that may be generated.

In accordance with the present invention, there is provided a focus control device including a moving member integral with an object lens, a focus actuator for moving the object lens toward or away from a recording surface of an optical disc in a direction of focusing, a tracking actuator for moving the object lens in a direction of tracking, and a control unit for biasing the moving member in the direction of tracking so that the moving member is pressed against a fixed member by using the tracking actuator, and for enabling the moving member to carry out a focusing operation while the moving member is pressed against the fixed member by using the focus actuator. As a result, the focus control device can completely exclude the influence of unnecessary turbulence vibrations, such as resonance, upon the moving member when carrying out a focusing operation, and therefore can surely carry out the focusing operation.

Further objects and advantages of the present invention will be apparent from the following description of the preferred embodiments of the invention as illustrated in the accompanying drawings.

### BRIEF DESCRIPTION OF THE DRAWINGS

FIG. 1 is circuit diagram showing a part of a focus control device according to embodiment 1 of the present invention;

FIG. 2 is a graph showing a relationship among a focus control signal, a tracking control signal, a focus error signal, and a tracking error signal for use in the focus control device as shown in FIG. 1;

FIG. 3 is a flow chart showing a controlling procedure of the focus control device as shown in FIG. 1;

FIG. 4 is a graph showing a relationship between the focus control signal and a lens displacement in the focus control device shown in FIG. 1;

FIG. 5 is a graph showing a relationship among a focus control signal, tracking control signals, a focus error signal, and a tracking error signal for use in a focus control device according to embodiment 2 of the present invention;

FIG. 6 is a flow chart showing a control procedure of a focus control device according to embodiment 3 of the present invention;

FIG. 7 is a block diagram showing the structure of a prior art disc drive;

FIG. 8 is a perspective view showing an enlarged main part of an optical pickup for use in the prior art disc drive shown in FIG. 7;

FIG. 9 is circuit diagram showing a part of circuitry included in the disc drive shown in FIG. 7;

FIG. 10 is a graph showing characteristics of the optical pickup shown in FIG. 7;

FIG. 11 is a graph showing a relationship between a focus control signal and a focus error signal in the disc drive shown in FIG. 7; and

FIG. 12 is a graph showing a relationship among the focus control signal, the focus error signal and a lens displacement when the optical pickup vibrates.

### DETAILED DESCRIPTION OF THE PREFERRED EMBODIMENTS

The invention will now be described with reference to the accompanying drawings.

Embodiment 1.

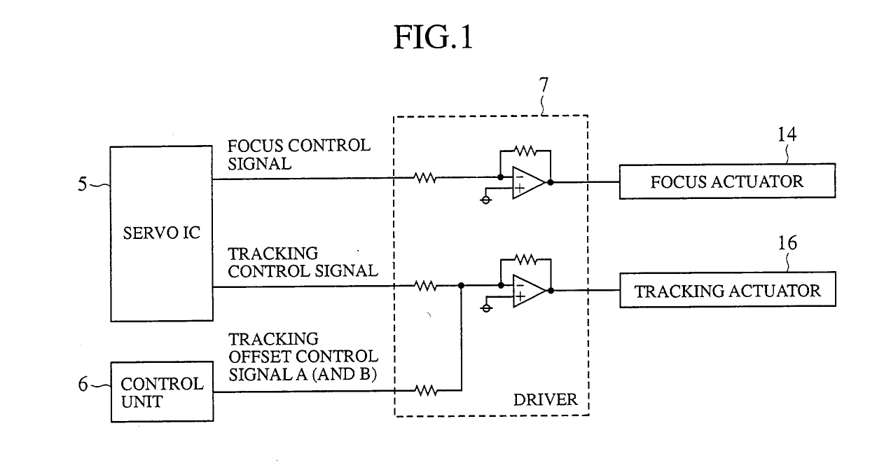

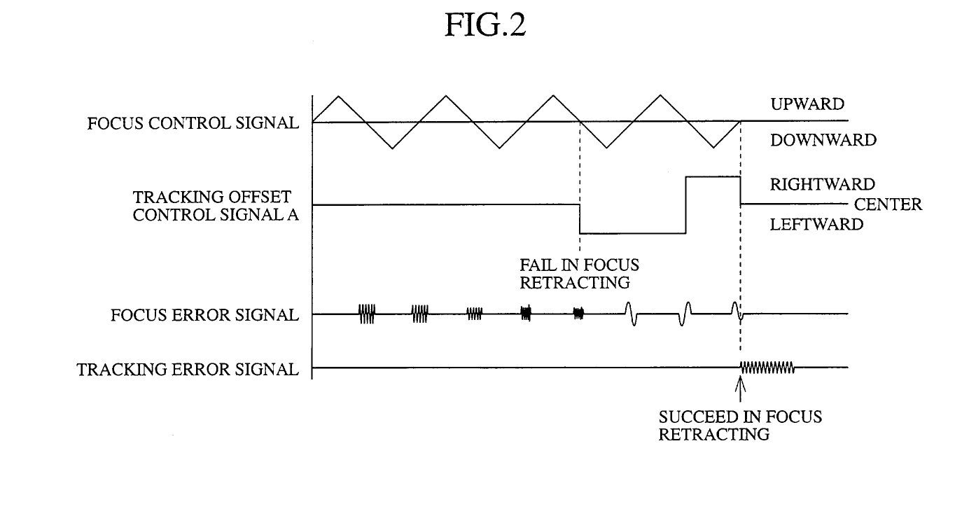

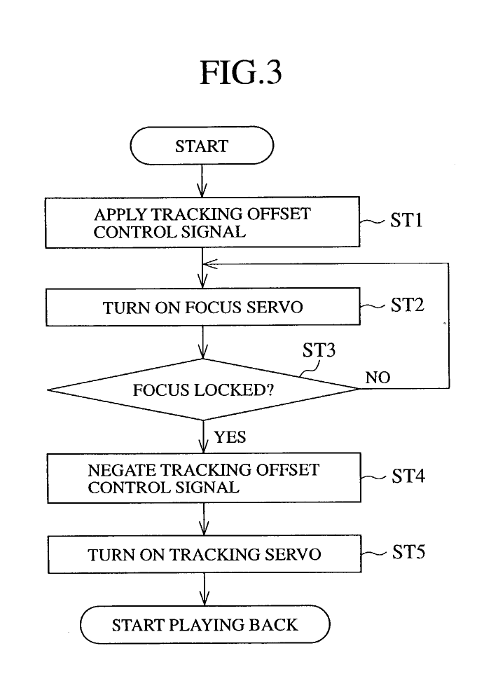

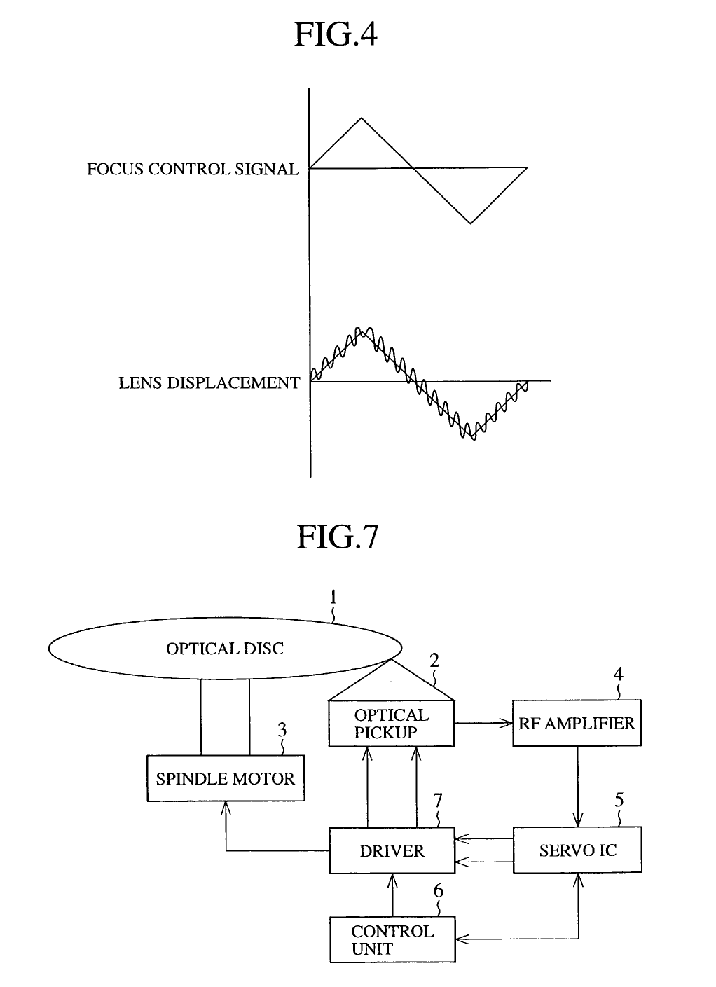

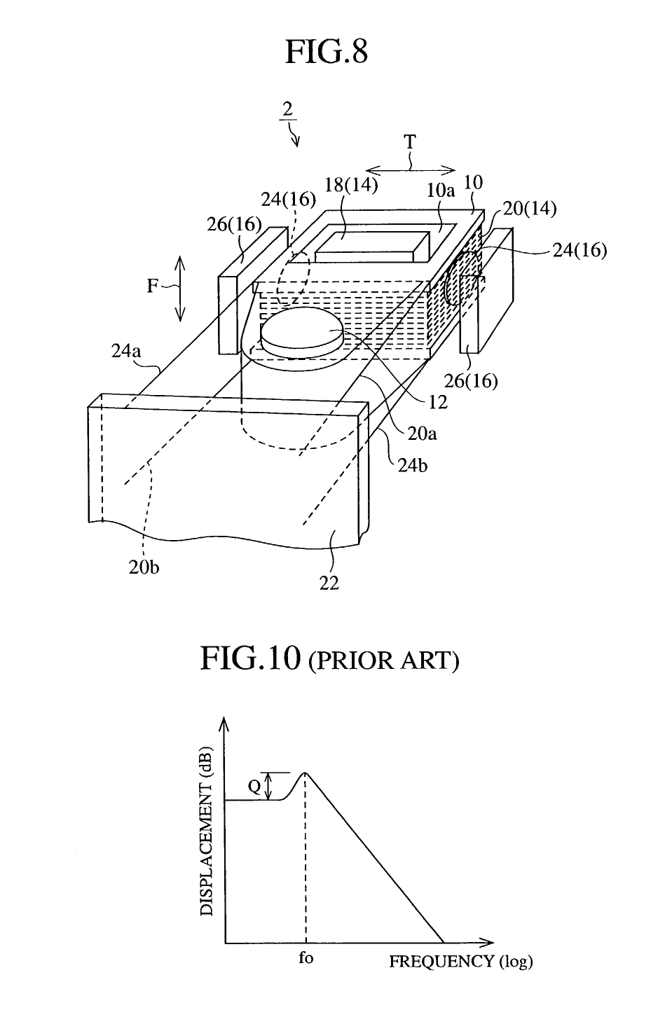

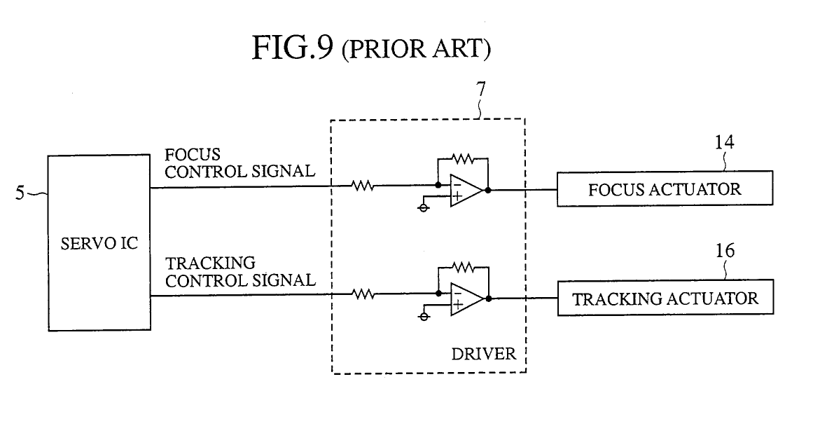

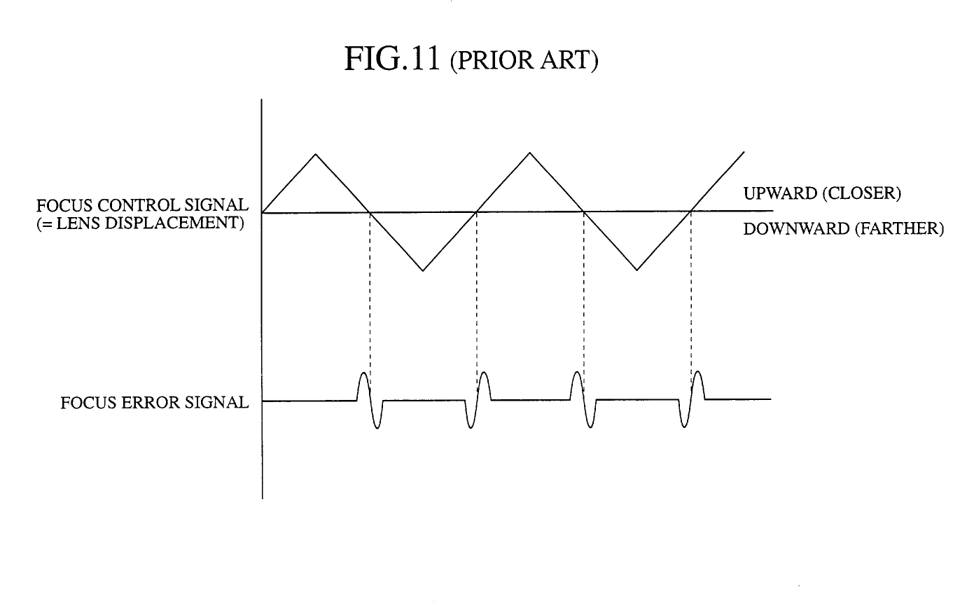

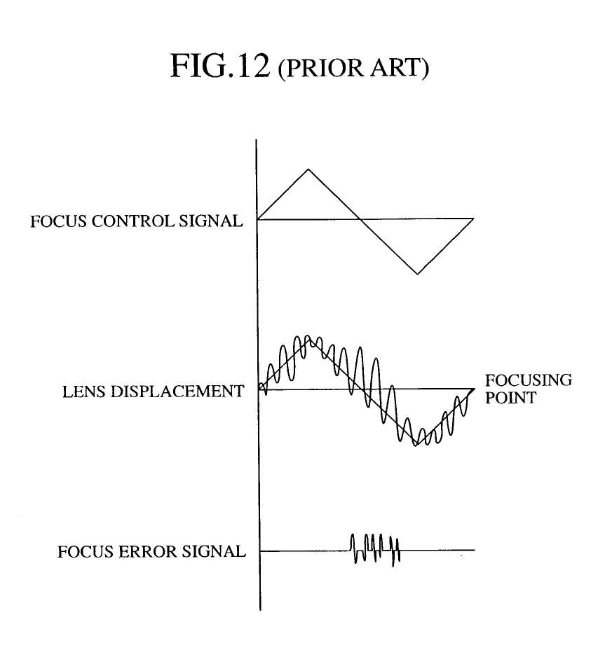

FIG. 1 is a circuit diagram showing a part of circuitry included in a focus control device according to embodiment 1 of the present invention, FIG. 2 is a graph showing a relationship among a focus control signal, a tracking control offset signal, a focus error signal, and a tracking error signal for use in the focus control device as shown in FIG. 1, FIG. 3 is a flow chart showing a controlling procedure of the focus control device as shown in FIG. 1, and FIG. 4 is a graph showing a relationship between the focus control signal and a lens displacement in the focus control device shown in FIG. 1. Among all components of this embodiment 1, the same components as those of the prior art disc drive as shown in FIGS. 7 and 8 are designated by the same reference numerals, and the explanation of those components will be omitted hereafter.

The focus control device according to this embodiment 1 is characterized in that it carries out a focusing operation while applying a tracking offset control signal A from a control unit 6 to a driver 7 in addition to the focus control signal and tracking control signal that are normally sent from a servo IC 5 when starting to play back an optical disc 1, as shown in FIG. 1. The tracking offset control signal A is a signal intended for, while an object lens 12 integral with a frame 10, which is a moving member as shown in FIG. 8, is made to move upwards or downwards with respect to a recording surface of the optical disc 1 according to the focus control signal, as shown in FIG. 2, making the frame 10 move in one tracking direction (in this case, move leftward toward the optical disc 1) at timing of focus retracting so that an inner wall face of an opening 10a of the frame 10 comes into contact with a yoke (i.e., a fixed member) 18, for keeping this state in which the opening 10a of the frame 10 is in contact with the yoke 18 for a while, and for then making the frame 10 move in another tracking direction (in this case, move rightward) at other timing of focus retracting so that another inner wall face of the opening 10a of the frame 10 comes into contact with the yoke 18.

Next, a description will be made as to an operation of the focus control device. First of all, when the focus control device carries out a focusing operation, as shown in FIG. 3, the focus control device applies the tracking offset control signal to a tracking actuator 16 (in step ST1). As a result, the focus control device can press the frame 10 which is a moving member against the yoke 18 which is a fixed member so that the frame 10 can slidably move with respect to the yoke 18 when the object lens 12 is made to move upwards or downwards. Therefore, even if an optical pickup 2 resonates when turbulence vibrations are generated at a frequency close to the resonance frequency f0 of the optical pickup 2, for example, the focus control device can exclude the influence of vibrations upon the object lens 12 integral with the frame 10. The tracking control signal has a high impedance at times of focus retracting, and the tracking actuator 16 can be controlled with only the tracking offset control signal.

The focus control device then turns on a focus servoloop (in step ST2), and carries out a focus retracting operation. When the focus control device fails to carry out the focus retracting operation, it returns to step ST2 in which it continues to repeatedly carry out the focus retracting operation until succeeds in carrying out the focus retracting operation. The focus control device negates the tracking offset control signal when succeeding in the focus retracting operation (in step ST4). As a result, the frame 10 is made to be apart from the yoke 18, and is made to return to a tracking center position by a return force caused by a suspension that consists of the two ends of a focusing coil 20 and the two ends of a tracking coil 24. After that, the focus control device turns on the tracking servoloop (in step ST5) so as to adjust a displacement of the optical axis of the object lens 12 in a direction of tracking. As a result, recorded information on the optical disc 1 can be played back.

As mentioned above, in accordance with this embodiment 1, when the focus control device carries out a focusing operation on the object lens 12, the focus control device applies a tracking offset control signal A to the tracking actuator 16 so that the frame 10 which is a moving member is pressed against the yoke 18 which is a fixed member. Therefore, even if the optical pickup 2 resonates when turbulence vibrations are generated at a frequency close to the resonance frequency f0 of the optical pickup 2, for example, the focus control device can exclude the influence of vibrations upon the object lens 12 integral with the frame 10 and can surely carry out the focusing operation.

Furthermore, in accordance with this embodiment 1, because the focus control device is so constructed as to change the direction in which the frame is pressed against the yoke 18 according to the tracking offset control signal, the focus control device can prevent the suspension from becoming deformed, thereby extending the life of the suspension.

Embodiment 2.

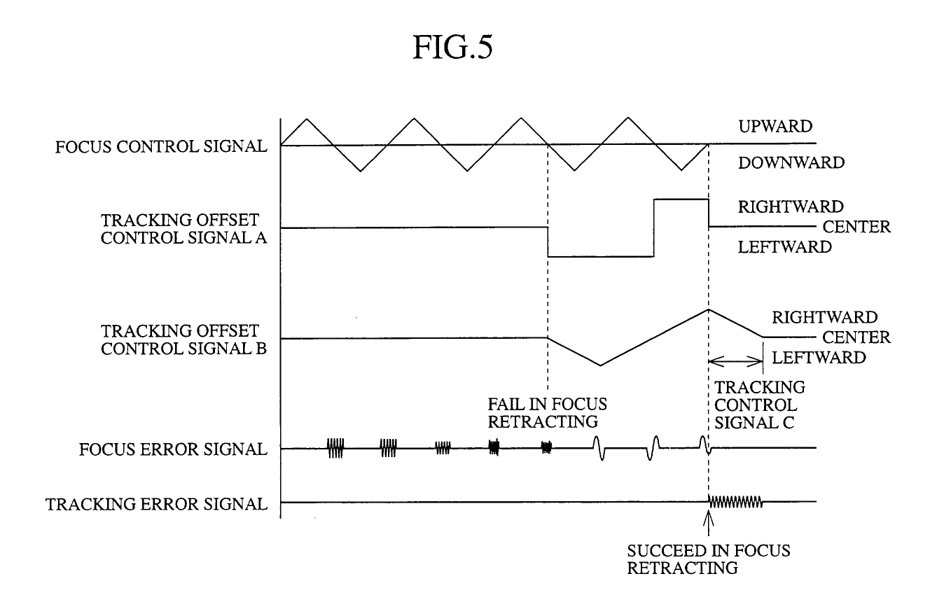

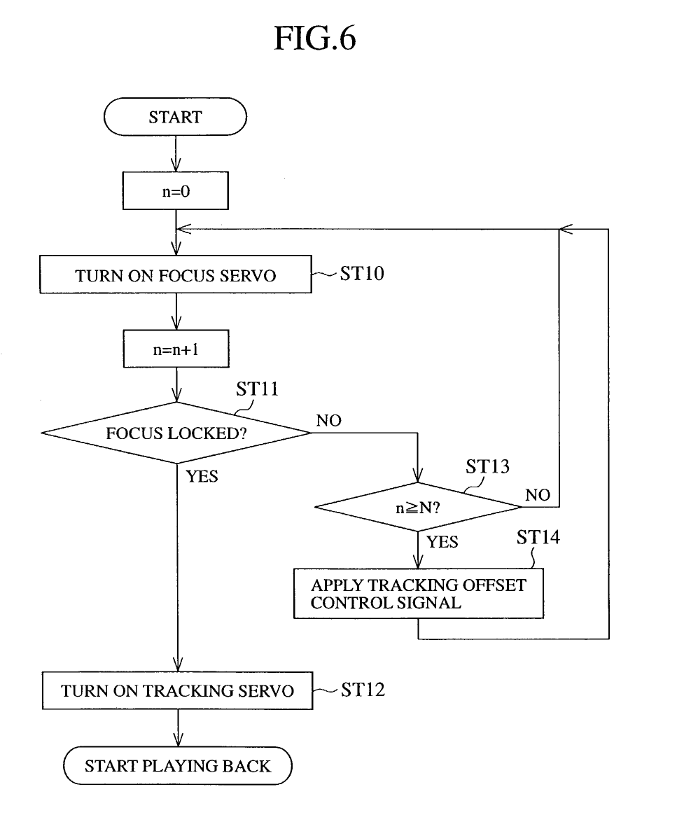

FIG. 5 is a graph showing a relationship among a focus control signal, a tracking control signal, tracking offset control signals, a focus error signal, and a tracking error signal for use in a focus control device according to embodiment 2 of the present invention. Among all components of this embodiment 2, the same components as those of the prior art disc drive as shown in FIGS. 6 and 7 or those of the focus control device according to embodiment 1 as shown in FIGS. 1 to 4 are designated by the same reference numerals, and the explanation of those components will be omitted hereafter.

In accordance with above-mentioned embodiment 1, it is expected that an inner wall face of the opening 10a of the frame 10 integral with the object lens 12 is quickly pressed against the yoke 18 according to the tracking offset control signal A, and there is a possibility that unnecessary vibrations due to deformation caused in the suspension or the like or the collision between the frame 10 and the yoke 18 are generated. In contrast, the focus control device according to this embodiment 2 carries out a focusing operation while applying another tracking offset control signal B having a triangular waveform from a control unit 6 to a driver 7. The other tracking offset control signal B is a signal intended for, while the object lens 12 integral with the frame 10 which is a moving member as shown in FIG. 8 is made to move upwards or downwards with respect to a recording surface of the optical disc 1 according to the focus control signal, as shown in FIG. 5, making the frame 10 gradually move in one tracking direction (in this case, move leftward toward the optical disc 1) so that an inner wall face of the opening 10a of the frame 10 comes into contact with the yoke (i.e., a fixed member) 18 at timing of focus retracting, for making the frame 10 gradually go back immediately after the inner wall face of the opening 10a of the frame 10 comes into contact with the yoke, and for then making the frame 10 gradually move in another tracking direction (in this case, move rightward) so that another inner wall face of the opening 10a of the frame 10 comes into contact with the yoke 18 at other timing of focus retracting. The other tracking offset control signal B includes the tracking control signal C intended for returning the frame 10 to a tracking center position after the focus control device succeeds in carrying out the focus retracting operation.

As mentioned above, in accordance with this embodiment 2, when the focus control device causes the object lens 12 to carry out a focusing operation, the focus control device applies a tracking offset control signal B having a triangle waveform to a tracking actuator 16 so that the frame 10 integral with the object lens 12 which is a moving member is pressed against the yoke 18 which is a fixed member. Therefore, in addition to the same advantage as provided by above-mentioned embodiment 1, the present embodiment offers an advantage of being able to prevent an inner wall face of the opening 10a of the frame 10 integral with the object lens 12 from being quickly pressed against the yoke 18, thereby preventing unnecessary vibrations that can be created when quickly biasing the frame 10 (i.e., applying a tracking offset to the frame 10) from occurring due to deformation caused in the suspension or the collision between the frame 10 and the yoke 18.

Furthermore, in accordance with this embodiment 2, because the tracking offset control signal B that makes it possible for the tracking actuator 16 to adjust the amount of biasing the frame 10 is applied to the tracking actuator 16, the focus control device can prevent unnecessary vibrations, which can occur due to deformation in the suspension or the like or the collision between the frame and the yoke when the amount of biasing the frame is too large, and can also prevent the unstability of the focus retracting, which can occur when turbulence vibrations at a frequency close to the resonance frequency are generated because the amount of biasing the frame is too small, unlike that of above-mentioned embodiment 1 with a fixed amount of biasing the frame with respect to the yoke. The tracking offset control signal B can be a signal having a sine waveform other than the one having a triangular waveform.

In addition, in accordance with this embodiment 2, because the focus control device is so constructed as to apply a tracking control signal C intended for returning the frame 10 to the tracking center position to the tracking actuator 16 after succeeding in the focus retracting operation, the focus control device can release the offset control with stability by gradually returning the frame 10 to the tracking center position when making the frame 10 that has been pressed against the yoke 18 leave the yoke, thereby preventing defocusing from occurring when the frame quickly returns to the tracking center position.

Embodiment 3.

FIG. 6 is a flow chart showing a control procedure of a focus control device according to embodiment 3 of the present invention. Among all components of this embodiment 3, the same components as those of the prior art disc drive as shown in FIGS. 7 and 8 or those of the focus control devices according to embodiments 1 and 2 as shown in FIGS. 1 to 5 are designated by the same reference numerals, and the explanation of those components will be omitted hereafter.

The focus control device according to this embodiment 3 is provided to overcome the following drawback of that of above-mentioned embodiment 1. There is a possibility that deformations appear in the suspension or the like if the focus control device according to above-mentioned embodiment 1 carries out tracking offset control whenever it carries out a focusing operation because it has a narrower band which is under the influence of the resonance frequency as compared with the actual focus servo band. To solve this problem, the focus control device according to this embodiment 3 carries out tracking offset control when needed.

Next, a description will be made as to an operation of the focus control device according to embodiment 3. First of all, the focus control device turns on a focus servoloop as shown in FIG. 6 (in step ST10), and then carries out a focus retracting operation. When the focus control device succeeds in the focus retracting operation (in step ST11), it turns on a tracking servoloop (in step ST12) so as to adjust a displacement of the optical axis of an object lens 12 in a direction of tracking. As a result, recorded information on an optical disc 1 can be played back.

When the focus control device fails to carry out the focus retracting operation a number of times n (<N) (in step ST13), where n is equal to the number of times which the focus control device carries out the focusing operation and N is a predetermined number of times, the focus control device returns to step ST10 in which it continues to carry out the focusing operation with the focus servoloop. When the focus control device fails to carry out the focus retracting operation the predetermined number of times or more, the focus control device applies a tracking offset control signal B as shown in FIG. 2 to a tracking actuator 16 for the first time, for example, while carrying out the focusing operation (in step ST14). While keeping this state, the focus control device then returns to step ST10 in which it turns on the focus servoloop and continues to carry out the focusing operation with the focus servoloop until succeeding in the focus retracting operation. When the focus control device succeeds in the focus retracting operation (instep ST11), it turns on the tracking servoloop (in step ST12) so as to adjust a displacement of the optical axis of the object lens 12 in a direction of tracking. As a result, recorded information on the optical disc 1 can be played back.

As mentioned above, in accordance with this embodiment 3, because the focus control device is so constructed as to apply a tracking offset control signal to the tracking actuator 6 when needed instead of applying the tracking offset control signal to the tracking actuator 6 whenever it carries out the focusing operation, the focus control device can surely prevent deformations from appearing in the suspension or the like without unnecessary control operations.

In either of embodiments 1 to 3, when the focus control device carries out the focusing operation, it makes the frame 10 move upwards or downwards while it presses the frame 10 against the yoke 18 according to the tracking offset control signal. At that time, inner wall surfaces of the frame 10 slidably can move on the outer surface of the yoke 18 while the frame 10 is made to move upwards or downwards with respect to the yoke 18. However, there is a possibility that the focus control device does not succeed in the focus retracting operation when vibrations are generated due to the sliding of the frame 10 or the frame 10 cannot smoothly move upwards or downwards with respect to the yoke 18. Then, to ensure the smooth sliding, it is preferable that all inner wall surfaces of the opening 10a of the frame 10 and all surfaces of the yoke 18 that are in contact with each other are smoothly formed.

In addition, in either of embodiments 1 to 3, there is a possibility that the circuitry included in the focus control device is short-circuited and therefore an overcurrent flows because of wear of the frame 10 or a surface status of the focusing coil or the tracking coil when the frame 10 slides on the surface of the yoke 18 while the frame is made to move upwards or downwards with respect to the yoke 18. It is therefore preferable that insulation sheets are provided or another member is disposed between the yoke 18 and the frame so that the other member is brought into contact with the yoke 18, thereby preventing the focus control device from being short-circuited.

Furthermore, in either of embodiments 1 to 3, the yoke 18 that is a component of the focusing actuator 14 is used as the fixed member. However, in accordance with the present invention, the fixed member is not limited to the yoke 18 and only has to be the one that ensures that the frame 10 can slide in directions of focusing.

Many widely different embodiments of the present invention may be constructed without departing from the spirit and scope of the present invention. It should be understood that the present invention is not limited to the specific embodiments described in the specification, except as defined in the appended claims.

What is claimed is:

1. A focus control device comprising:
a moving member integral with an object lens, for holding the object lens that is opposite to a recording surface of an optical disc;
a focus actuator for moving the object lens toward or away from the recording surface of the optical disc in a direction of focusing;
a tracking actuator for moving the object lens in a direction of tracking; and
a control unit for biasing said moving member in the direction of tracking so that said moving member is pressed against a fixed member by using said tracking actuator, and for enabling said moving member to carry out a focusing operation while said moving member is pressed against said fixed member by using said focus actuator.

2. The focus control device according to claim 1, wherein when said moving member carries out a focusing operation, said control unit applies a tracking offset control signal that is either a sine wave or triangular wave to said tracking actuator.

3. The focus control device according to claim 2, wherein said control unit applies a tracking control signal to return said object lens to a tracking center position to said tracking actuator after carrying out a focus retracting operation on said object lens.

4. The focus control device according to claim 1, wherein when said moving member carries out a focusing operation, said control unit adjusts an amount of biasing said moving member in the direction of tracking.

5. The focus control device according to claim 1, wherein only when said control unit fails to carry out a focus retracting operation on said object lens a predetermined number of times, said control unit retries to bias said moving member in the direction of tracking so that said moving member is pressed against said fixed member by using said tracking actuator, and to enable said moving member to carry out a focusing operation while said moving member is pressed against said fixed member by using said focus actuator.
